(19) United States
(12) Patent Application Publication
(10) Pub. No.: US 2024/0239138 A1
(43) Pub. Date: Jul. 18, 2024

(54) Wheel of a single or double caster for furniture

(71) Applicant: STEINCO Paul vom Stein GmbH, Wermelskirchen (DE)

(72) Inventor: Tobias Weichbrodt, Wermelskirchen (DE)

(21) Appl. No.: 18/395,542

(22) Filed: Dec. 23, 2023

(30) Foreign Application Priority Data
Jan. 13, 2023 (DE) 102023100765.3

(51) Int. Cl. B60B 33/00

(52) U.S. Cl. CPC B60B 33/0028; B60B 33/0002; B60B 33/0042

(57) ABSTRACT

A wheel for a single or double caster for furniture or hospital beds or medical equipment, the wheel comprising: a rim; a tire; and a wheel bearing centrally arranged in the rim, wherein a running surface of the tire envelops the rim, and wherein the running surface of the tire includes a plurality of bonded spokes which are at least in contact the wheel bearing. The wheel is producible in a simple manner with short cycle times while having good thermal conductivity.

### RELATED APPLICATIONS

This application claims priority from German patent application DE 10 2023 100 765.3 filed on Jan. 13, 2023 which is incorporated in its entirety by this reference.

### FIELD OF THE INVENTION

The invention relates to a wheel for a single or double caster for furniture, hospital beds or medical equipment, comprising a rim and a tire and a wheel bearing, centrally arranged in the rim and wherein the tire envelops the rim with a running surface.

### BACKGROUND OF THE INVENTION

Wheels are known in the art that are made from two synthetic material components wherein a harder synthetic material component forms the rim and a soft synthetic material component forms the tire.

In these known wheels the wheel bearing is initially encased by the harder synthetic material component of the rim by injection molding. Thereafter the tire formed from a running surface and a bar that extends from the running surface to the wheel bearing is produced in a second injection molding step. In order to improve heat conductivity of the softer tire material, steel fibers are mixed in which are evenly distributed in the injection molding process, at least theoretically.

When the wheel is fabricated according to this method where the rim is injection molded first and the tire thereafter, the relatively long cycle time is a great disadvantage because cooling the rim and the tire requires a lot of time.

### BRIEF SUMMARY OF THE INVENTION

Thus, it is an object of the invention to provide a new wheel for a single or double caster for furniture, hospital beds or medical equipment which is producible in a simple manner and with shorter cycle times while still having sufficient thermal conductivity.

The object is achieved by a wheel for a single or double caster for furniture or hospital beds or medical equipment comprising: a rim; a tire; and a wheel bearing centrally arranged in the rim, wherein a running surface of the tire envelops the rim, and wherein the running surface of the tire includes a plurality of bonded spokes which are at least in contact the wheel bearing.

The wheel according to the invention facilitates reduced cycle times since the tire can be advantageously injection molded in a first step and cools quickly thereafter so that the second injection molding step can be performed quickly which reduces cycle time. Additionally thermal conductivity between the tire and the wheel bearing is rather high since a plurality of contact points is provided between the wheel bearing and the plurality of spokes bonded to the running surface.

In an advantageous embodiment of the invention the spokes are connected with an inner ring that at least partially envelops the wheel bearing. This embodiment is advantageous in that the wheel bearing is reliably positioned in the inner ring of the tire before the second injection molding step and in addition to that a large contact surface is provided between the wheel bearing and the tire.

According to an advantageous embodiment of the invention, the tire includes a thickened cross section on at least two sides of each respective spoke forming a reaction bearing for a spoke during fabrication of the rim.

Last not least the tire material can include additives that improve thermal conductivity from the wheel bearing to the tire running surface.

The invention also relates to a method for producing a wheel of a single or double caster for furniture, hospital beds, or similar, the wheel including a tire, a rim and a wheel bearing wherein the tire is injection molded in a first step and the rim is injection molded in a second step.

Improving upon known methods, the object is achieved by a method for producing a wheel of a single or double caster for furniture, hospital beds or similar including a tire, a rim and a wheel bearing wherein the tire is injection molded in a first step and the rim is injection molded in a second step, the method comprising:
inserting the wheel bearing into a cavity of a synthetic material injection molding tool in order to perform a first injection molding step;
performing the first injection molding step for fabricating a tire including a running surface and a plurality of spokes that contact the wheel bearing;
cooling the tire;
extracting the tire from the injection molding tool using a transport device adapted to a shape of the tire;
transporting the tire into a cavity of a second injection molding tool before performing a second injection molding step;
performing the second injection molding step for producing the rim; and
cooling the wheel and retrieving the wheel from the second injection molding tool.

The method according to the invention has the essential advantage that the cycle time for producing the wheel is significantly reduced.

The reduced cycle time is caused on the one hand side by a reduced time that is needed for filling the injection molding tool through the plurality of spokes and on the other hand side in that the tire made from the running surface and the plurality of spokes cools relatively quickly so that the tire can be transported in order to perform the second injection molding step.

It is an advantage of the method that the tire produced in the first injection molding step can cool immediately through all its surfaces after the first injection molding step, whereas a prior art tire contacts the previously produced rim with a large surface area of the prior art tire while the rim is still warm.

There is good thermal conductivity between the running surface and the wheel bearing as well.

According to an advantageous embodiment of the invention the tire is produced in the first injection mold by a plurality of injection points at an edge of the inserted wheel bearing which further reduces the time required for filling the injection molding tool.

Last not least the invention also relates to an injection molding tool for producing a tire of a single or double caster for furniture and hospital beds, the injection molding tool including at least one cavity for a running surface of a tire.

Improving upon the prior art the object is achieved by an injection molding tool for producing a tire of a single or double caster for furniture, hospital beds or medical equipment, the injection molding tool comprising at least one cavity for a running surface of a tire, wherein the at least one cavity includes portions configured for producing a plurality of spokes.

The injection molding tool according to the invention has the essential advantage that the tire can be produced rather quickly with a short cycle time and transported into a second plastic injection molding tool for producing the rim or the finished wheel after a short cooling time as recited supra.

The injection molding tool can be advantageously configured so that partial cavities for producing the spokes are connected with an additional partial cavity configured to produce a ring that partially envelops the wheel bearing.

### BRIEF DESCRIPTION OF THE DRAWINGS

Additional advantages of the invention can be derived from the subsequent description of an advantageous embodiment, wherein:

FIG. 1 illustrates a perspective view of a tire with a wheel bearing;

FIG. 2 illustrates a top view of the wheel bearing;

FIG. 3 illustrates a top view of the tire and the wheel bearing;

FIG. 4 illustrates a top view of a wheel including a rim, a tire and a wheel bearing from a first side;

FIG. 5 illustrates a top view of a wheel with rim, tire and wheel bearing from a second side;

FIG. 6 illustrates a sectional view of the wheel according to the sectional line VI-VI in FIG. 4; and

FIGS. 7-12 illustrate an injection molding process for producing the tire in sequential steps.

### DETAILED DESCRIPTION OF THE INVENTION

A wheel is designated overall with reference numeral 10 in the drawing figures. The wheel 10 is formed by a tire 11, a rim 12 and a wheel bearing 13. The rim is made from a harder synthetic material, whereas the tire is made from a softer synthetic material with added steel fibers.

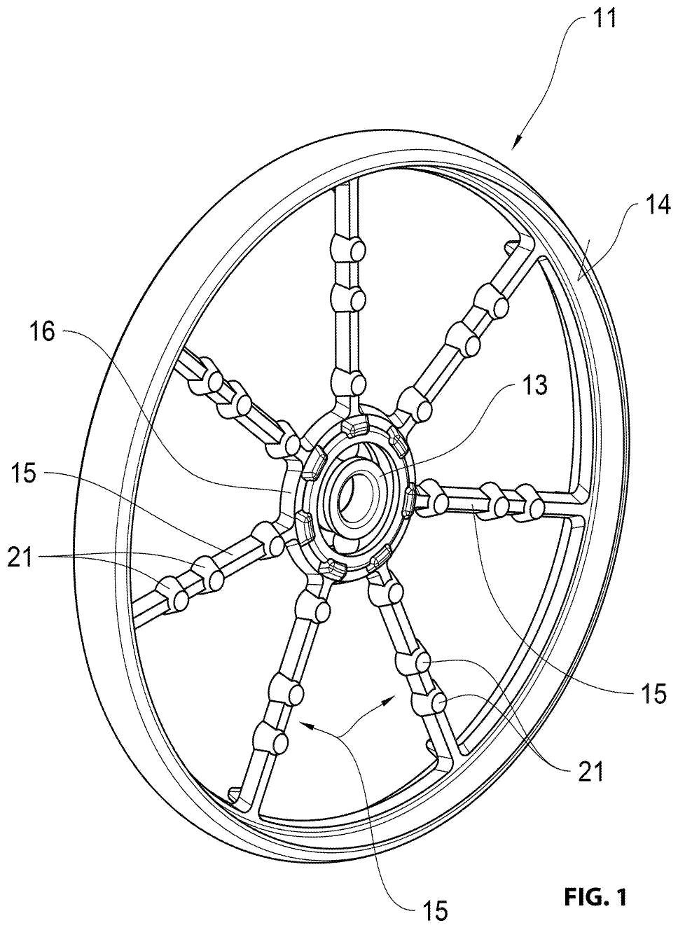

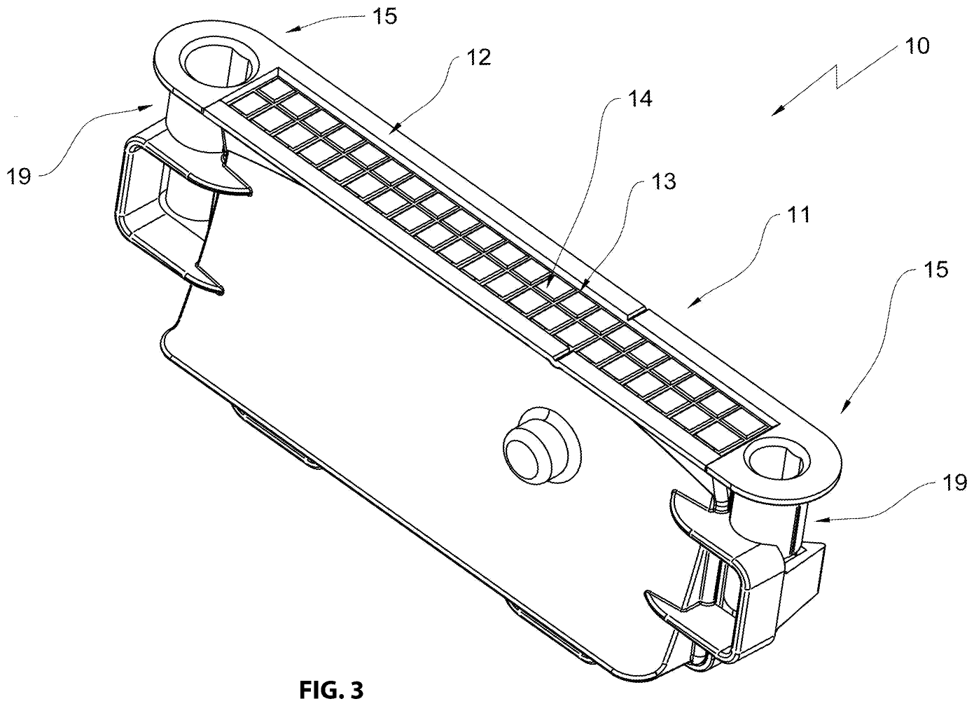

FIGS. 1 and 3 respectively show a tire 11, including a running surface 14, seven spokes 15 and an inner ring 16 that is used for arranging the wheel bearing 13.

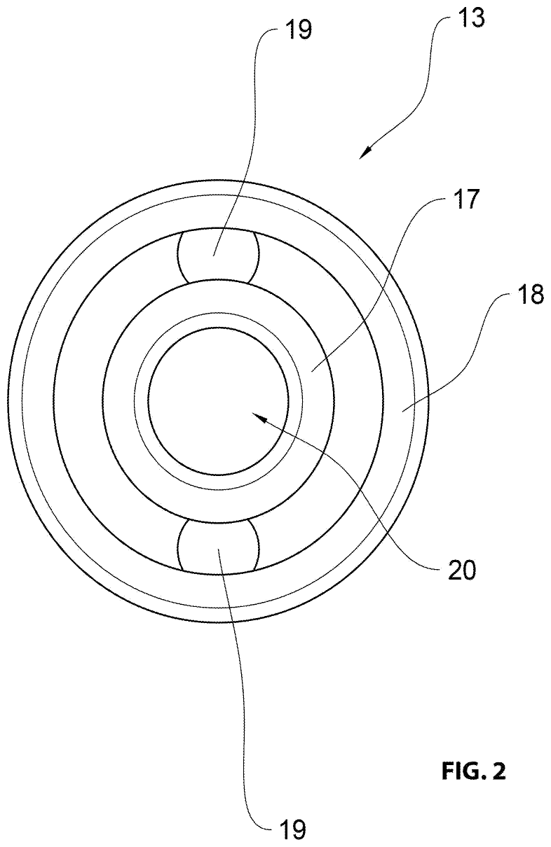

It is evident in particular from FIG. 2 that the wheel bearing 13 is formed from an inner bearing race 17 and an outer bearing race 18 and balls 19 and an axle receiver 20.

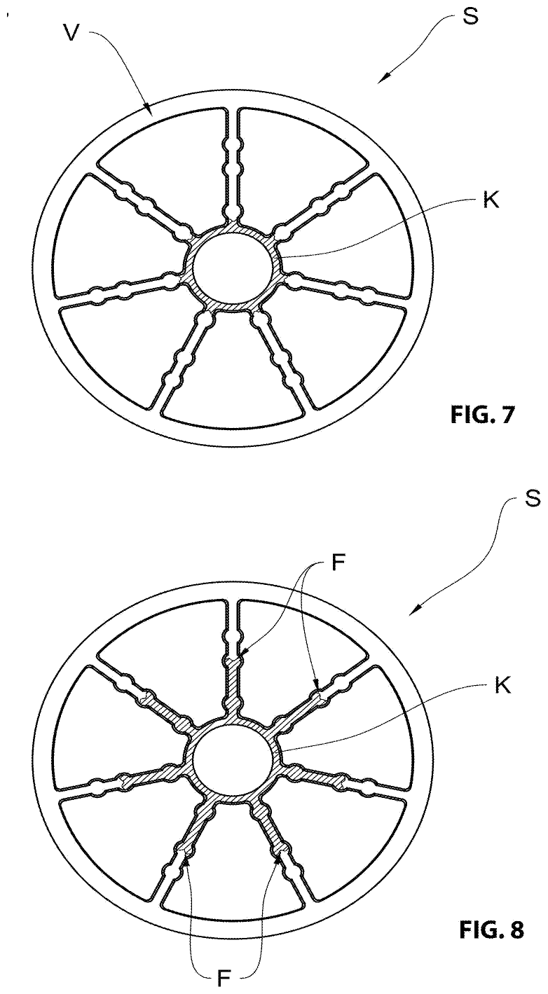

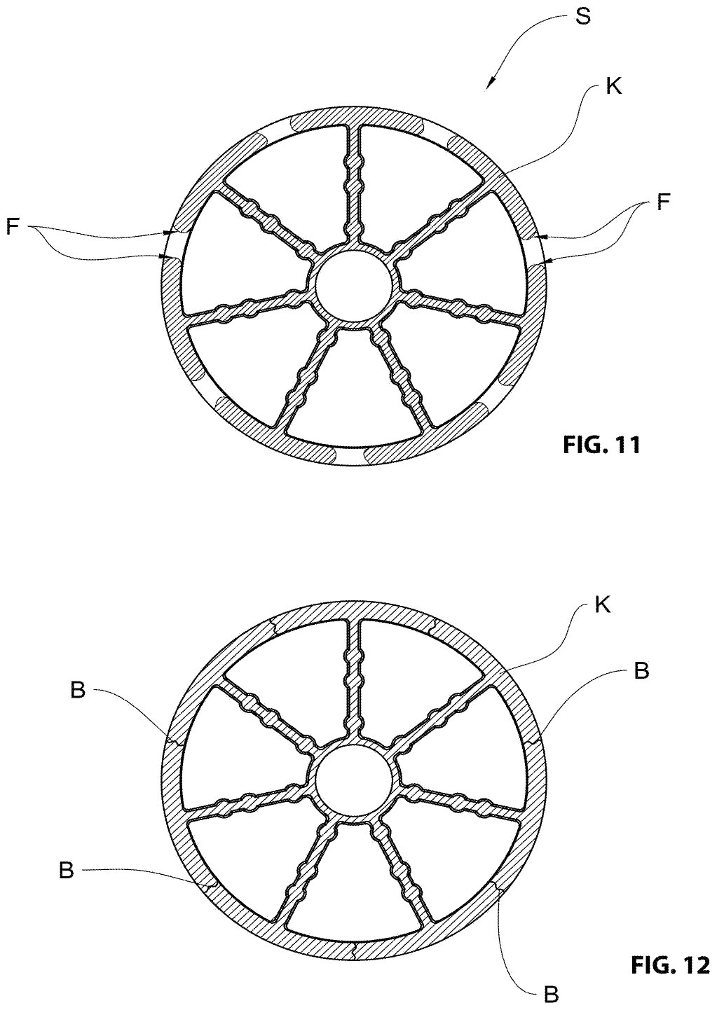

The tire 11 is produced in a first injection molding tool S (cf. FIGS. 7-12) in the embodiment described supra, wherein the wheel bearing 13 is initially inserted into the injection molding tool. After completion of the injection molding process a cooling is performed until the tire 11 is retrieved from the injection molding tool S so that the tire can be inserted into a second injection molding tool to produce the rim 12 and thus the entire wheel 10.

Cross section increases 21 provided on both sides of the spokes 15 are important for producing the rim 12 in the second injection molding tool wherein the cross section increases provide retaining points for the spokes 15 during production of the rim 12. These cross section increases or indentations 21 in a spoke 15 assure that the spokes 15 are arranged straight in the rim 12 even after encasing the spokes 15 by injection molding.

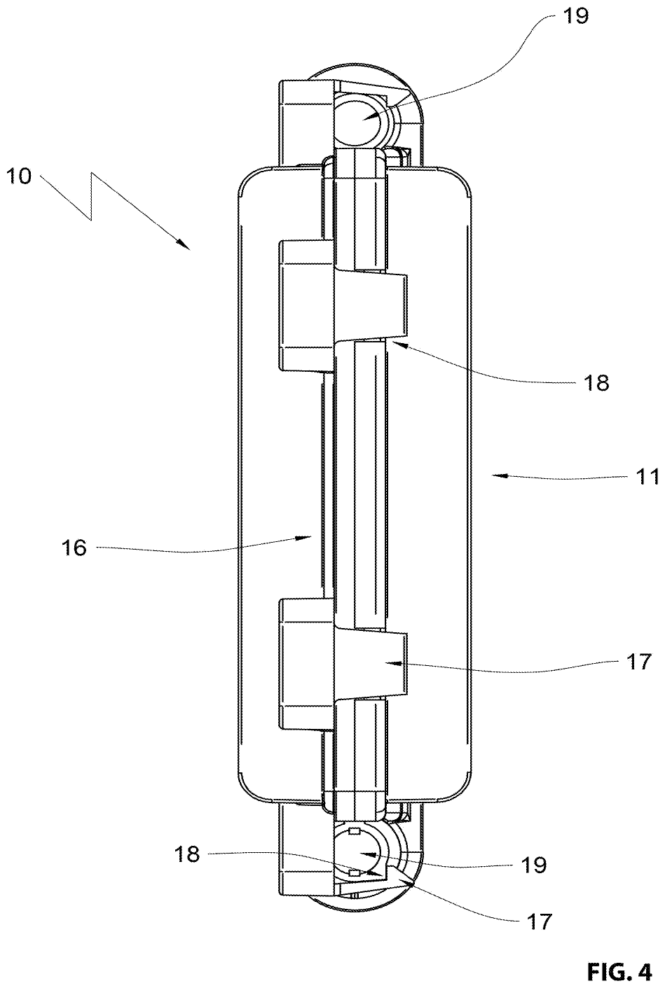

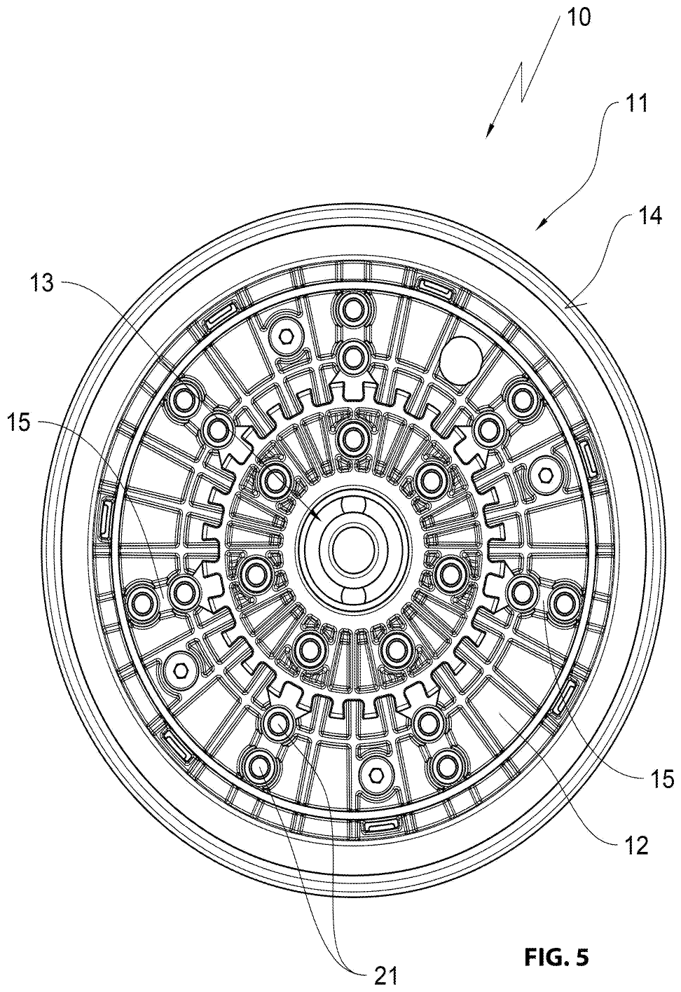

FIGS. 4 and 5 show the two top views of the finished wheel 10 from different sides, the wheel including a tire 11, a rim 12, and a wheel bearing 13. It is evident that the running surface 14 runs about an outside of the rim 12 and that the spokes 15 besides the faces of the thickened cross sections 21 are encased by injection molding. Eventually the injection molding step of the rim 12 fixes the wheel bearing 13 in the wheel 10.

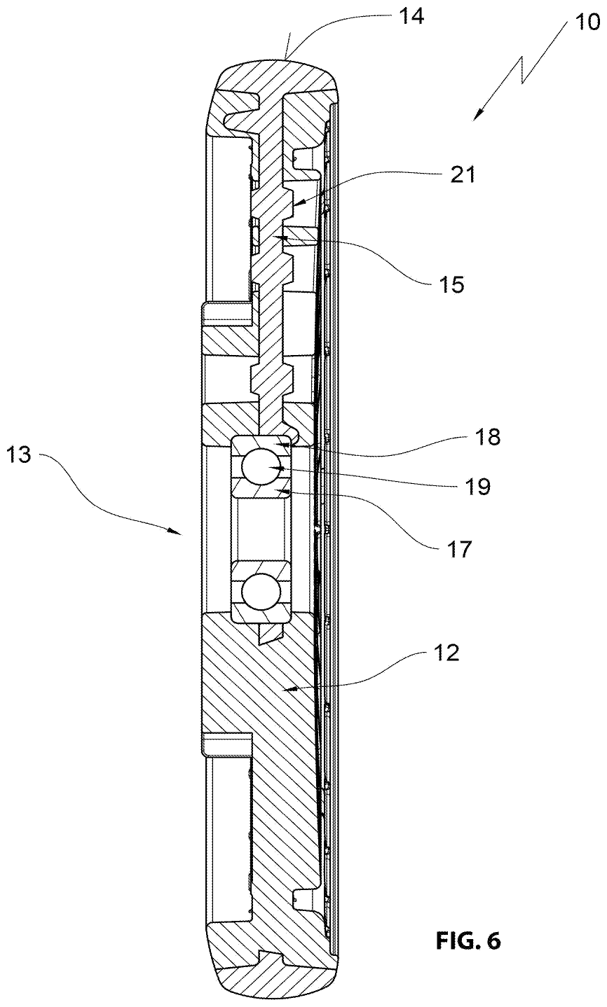

FIG. 6 shows a central sectional view of the wheel 10 according to the sectional lines VI-VI in FIG. 4.

FIGS. 7-12 show the first injection molding step for producing the tire 11 in various steps in top views of the injection molding tool S.

Starting from one or plural injection points, a cavity V of the illustrated injection molding tool S is initially filled in the portion of the inner ring 16 (cf. FIG. 7) wherein frontal flow areas F of the liquid synthetic material evenly move outward through the spokes 15 in an outward direction (cf. FIG. 8).

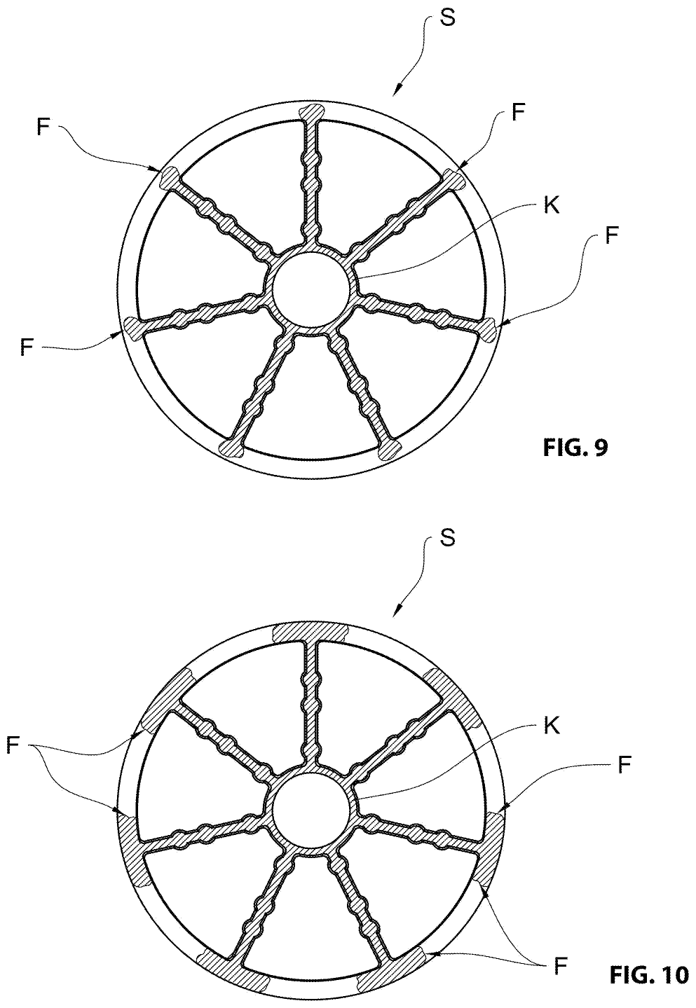

FIGS. 9-12 show a two-sided progression of two flow fronts F of the liquid synthetic material K in the portion of the cavity V for the running surface 15 starting at each spoke 15 so that the seven flow fronts F of the liquid synthetic material K join in the portion of the running surface 14 after completion of the injection molding step and form binding seams B at the joints.

The inventors have found that the steel fibers are radially oriented in the portion of the binding seams B so that the running surface 14 has a higher thermal conductivity in these portions.

### REFERENCE NUMERALS AND DESIGNATIONS

10 wheel
11 tire
12 rim
13 wheel bearing
14 running surface
15 spoke
16 inner ring
17 inner bearing race
18 outer bearing race
19 ball
20 axle receiver
21 cross section increase in 15
V cavity
S injection molding tool
F flow front
B binding seam
K liquid synthetic material

What is claimed is:

1. A wheel for a single or double caster for furniture or hospital beds or medical equipment, the wheel comprising:
a rim;
a tire; and
a wheel bearing centrally arranged in the rim,
wherein a running surface of the tire envelops the rim, and
wherein the running surface of the tire includes a plurality of bonded spokes which are in contact with or bonded to the wheel bearing.

2. The wheel according to claim 1, wherein the spokes are connected by an inner ring that at least partially envelops the wheel bearing.

3. The wheel according to claim 1, wherein the tire includes at least one respective double sided cross section increase in a portion of each spoke forming a support point for the spoke during fabrication of the rim.

4. The wheel according to claim 1, wherein a material of the tire includes additives improving thermal conductivity of the wheel bearing and the running surface.

5. A method for producing a wheel of a single or double caster for furniture, hospital beds or similar, the wheel including a tire, a rim and a wheel bearing wherein the tire is injection molded in a first injection molding step and the rim is injection molded in a second injection molding step, the method comprising:
inserting the wheel bearing into a cavity of a first synthetic material injection molding tool in order to perform the first injection molding step;
performing the first injection molding step including fabricating the tire including the running surface and a plurality of spokes that contact the wheel bearing;
cooling the tire fabricated in the first injection molding step;
extracting the tire from the first synthetic material injection molding tool using a transport device adapted to a shape of the tire;
transporting the tire into a cavity of a second synthetic material injection molding tool in order to perform a second injection molding step;
performing the second injection molding step including producing the rim; and
cooling the wheel and retrieving the wheel from the second synthetic material injection molding tool.

6. The method according to claim 5, wherein the tire is produced in the first synthetic material injection molding tool by a plurality of injection points arranged at an edge of the wheel bearing inserted into the first synthetic material injection molding tool.

7. An injection molding tool for producing a tire for a single or double caster for furniture, hospital beds or medical equipment, the injection molding tool comprising:
at least one cavity for a running surface of the tire,
wherein the at least one cavity includes additional portions configured for producing a plurality of spokes.

8. The injection molding tool according to claim 7, wherein the additional portions that produce the plurality of the spokes are connected with another partial cavity that produces a ring that partially envelops a wheel bearing.
